(19) United States
(12) Patent Application Publication
(10) Pub. No.: US 2025/0008606 A1
(43) Pub. Date: Jan. 2, 2025

(54) METHOD AND APPARATUS FOR MANAGING PDU SESSION ESTABLISHMENT FOR DISASTER ROAMING SERVICE

(71) Applicant: Samsung Electronics Co., Ltd., Gyeonggi-do (KR)

(72) Inventors: Mahmoud WATFA, Middlesex (GB); Lalith KUMAR, Bangalore (IN)

(21) Appl. No.: 18/707,013

(22) PCT Filed: Nov. 2, 2022
(86) PCT No.: PCT/KR2022/016989

§ 371 Date: May 2, 2024

(30) Foreign Application Priority Data
Nov. 2, 2021 (IN) 202131050340
May 4, 2022 (IN) 202231026016
Nov. 1, 2022 (GB) 2216182.2

(51) Int. Cl. H04W 76/50; H04W 28/02; H04W 76/10; H04W 76/25

(52) U.S. Cl. CPC H04W 76/50; H04W 28/0268; H04W 76/10; H04W 76/25

(57) ABSTRACT

The disclosure relates to a 5G or 6G communication system for supporting a higher data transmission rate. A method for managing Protocol Data Unit, PDU, session establishment, by a user equipment, UE, connected to a network for disaster roaming is disclosed. The method comprises receiving a Non Access Stratum, NAS, session management message from the network; determining whether the NAS session management message includes an Evolved Packet System, EPS, related Quality of Service, QoS, parameter, and whether a session related to the NAS session management message is an emergency PDU session; and deleting an associated EPS bearer context based on determining that the NAS session management message includes the EPS related QoS parameter, and the session is not the emergency PDU session.

### TECHNICAL FIELD

The present disclosure relates to a method and an apparatus for managing Protocol Data Unit (PDU) session establishment for disaster roaming service and improved handling of Quality of Service, QoS, errors during the disaster roaming service.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

Disaster roaming is a service whereby a User Equipment, UE, registered with a first network is permitted to temporarily roam on a second network in the event that the first, home, network is afflicted by some form of outage, such as fire, earthquake or other disaster.

3GPP working groups have developed solutions to enable a UE to get service even when a disaster condition occurs on a Public Land Mobile Network, PLMN. In such a case, the UE is said to obtain disaster roaming service on a forbidden PLMN, when no other PLMN is available.

The study on disaster roaming service can be found in 3GPP TR 24.811, whereas normative specification for the related work has been specified in 3GPP TS 23.122, 23.501, and 24.501.

A UE may support both N1 mode and S1 mode. As such, if the network supports interworking between 5GS (N1 mode) and EPS (S1 mode), then PDU sessions can be transferred between 5GS and EPS.

For a PDU session to be transferable from 5GS to EPS, the mapped EPS bearer context must be received by the UE in the relevant Non-Access Stratum, NAS, 5GSM message e.g. in the PDU Session Establishment Accept message, that is sent from the network. For example, the following is stated in section 6.1.4.1 in TS24.501 regarding interworking and transferability of PDU sessions from 5GS to EPS:

“Interworking with EPS is supported for a PDU session, if the PDU session includes the mapped EPS bearer context(s) or has association(s) between QoS flow and mapped EPS bearer after inter-system change from S1 mode to N1 mode.”

In general, when the UE receives a NAS 5GSM message, e.g. a PDU Session Establishment Accept message, the UE verifies if there are any errors in the QoS parameters. If yes, then the UE may take an action to correct the QoS error. For example, the UE may support S1 mode but may not support the establishment of a PDN connection for the PDN type set to “non-IP” in S1 mode. In this case, the UE will behave as indicated below, where this behaviour is specified in TS24.501:

“If the selected PDU session type of the PDU session is “Unstructured” or “Ethernet”, the UE supports inter-system change from N1 mode to S1 mode, the UE does not support establishment of a PDN connection for the PDN type set to “non-IP” in S1 mode, and the parameters list field of one or more authorized QoS flow descriptions received in the Authorized QoS flow descriptions IE of the PDU SESSION ESTABLISHMENT ACCEPT message contains an EPS bearer identity (EBI), then the UE shall locally remove the EPS bearer identity (EBI) from the parameters list field of such one or more authorized QoS flow descriptions. Additionally the UE shall also initiate a PDU session modification procedure by sending a PDU SESSION MODIFICATION REQUEST message to delete the mapped EPS bearer context with 5GSM cause #85 “Invalid mapped EPS bearer identity”.”

Note that the different actions that may be taken to correct QoS errors are defined in TS24.501.

The prior art referred to above exhibits at least one problem. In particular, one problem relates to QoS Parameters Related to EPS being Received During Disaster Roaming. When the UE that is registered for disaster roaming establishes a new PDU session, the Session Management Function, SMF, may not be aware of the UE being registered for disaster roaming. As such, the SMF may include parameters that are related to EPS so as to enable PDU session transfer from N1 mode to S1 mode. However, disaster roaming service is only relevant to 5GS i.e. N1 mode, and so providing these parameters to the UE is incorrect as the UE may erroneously determine that the PDU session can be transferred to EPS i.e. S1 mode.

Note that even if the SMF is aware that the UE is registered for disaster roaming, the mapped EPS bearer may be erroneously provided to the UE and as such may be considered an abnormal case or an error case that needs to be corrected.

### DISCLOSURE OF INVENTION

### Technical Problem

However, there are currently no mechanisms in the prior art to correct such errors if they occur. Further, there are no means provided to prevent them occurring in the first instance.

It is an aim of embodiments of the present disclosure to address this and other shortcomings in the prior art, whether mentioned herein or not.

### Solution to Problem

According to the present disclosure there is provided an apparatus and method as set forth in the appended claims. Other features of the disclosure will be apparent from the dependent claims, and the description which follows.

According to an embodiment of the present disclosure, a method for managing Protocol Data Unit, PDU, session establishment, by a user equipment, UE, connected to a network for disaster roaming is disclosed. The method may comprise receiving a Non Access Stratum, NAS, session management message from the network. The method may comprise determining whether the NAS session management message includes an Evolved Packet System, EPS, related Quality of Service, QoS, parameter, and whether a session related to the NAS session management message is an emergency PDU session. The method may comprise; deleting an associated EPS bearer context based on determining that the NAS session management message includes the EPS related QoS parameter, and the session is not the emergency PDU session.

According to an embodiment of the present disclosure, a user equipment, UE, connected to a network for disaster roaming is disclosed. The UE may comprise a transceiver; and a controller coupled to the transceiver. The UE may be configured to receive a Non Access Stratum, NAS, session management message from the network. The UE may be configured to determine whether the NAS session management message includes an Evolved Packet System, EPS, related Quality of Service, QoS, parameter, and whether a session related to the NAS session management message is an emergency Protocol Data Unit, PDU, session. The UE may be configured to delete an associated EPS bearer context based on determining that the NAS session management message includes the EPS related QoS parameter, and the session is not the emergency PDU session.

According to an embodiment of the present disclosure, a non-transitory computer readable storage medium storing instructions is disclosed. The operations, when executed by a controller of a user equipment connected to a connected to a network for disaster roaming, cause the UE to perform operations. The operations may comprise receiving a Non Access Stratum, NAS, session management message from the network. The operations may comprise determining whether the NAS session management message includes an Evolved Packet System, EPS, related Quality of Service, QoS, parameter, and whether a session related to the NAS session management message is an emergency Protocol Data Unit, PDU, session. The operations may comprise deleting an associated EPS bearer context based on determining that the NAS session management message includes the EPS related QoS parameter, and the session is not the emergency PDU session.

Although embodiments of the present disclosure have been shown and described, it will be appreciated by those skilled in the art that various changes and modifications might be made without departing from the scope of the disclosure, as defined in the appended claims.

### BRIEF DESCRIPTION OF DRAWINGS

For a better understanding of the disclosure, and to show how embodiments of the same may be carried into effect, reference will now be made, by way of example only, to the accompanying diagrammatic drawings in which:

FIG. 1 shows a flowchart illustrating a method according to an embodiment of the present disclosure.

FIG. 2 shows a block diagram of a device according to an embodiment of the present disclosure.

### MODE FOR THE INVENTION

As mentioned above, the SMF may not be aware that a UE is registered for disaster roaming service and so may determine that a session can be transferred to S1 mode and, as such, may provide the mapped EPS bearer contexts to the UE during the establishment of a PDU session in N1 mode. In this case, the SMF may intentionally provide the related EPS bearer contexts to the UE, where this may happen because the SMF is unaware of the UE being registered for disaster roaming.

One way to avoid this from happening is to inform the SMF that a UE is registered for disaster roaming services. This may be achieved by either the Access and Mobility management Function, AMF, informing the SMF, or by the UE directly informing the SMF. Following this, the SMF should take specific actions as will be described below.

In a first embodiment, the AMF informs the SMF about a UE registered for disaster roaming service. Here, the AMF should inform the SMF whether the UE is registered for disaster roaming service. For example, if the UE is registered for disaster roaming service (where, for example, the UE indicates so in the registration type and/or the AMF indicates to the UE that it is registered for disaster roaming service), then the AMF should inform the SMF that the UE is registered for disaster roaming service.

For example, after the UE registration is complete, the AMF may send a message to each SMF that is handling the UE's 5GSM context to indicate that the UE is registered for disaster roaming if this is indeed the case. The AMF may use any message, on the protocol between the AMF and SMF, to provide this indication.

Additionally, when the AMF receives an “UL NAS TRANSPORT” message optionally with the Payload container type Information Element, IE, is set to “N1 SM information” and optionally with the Request type IE indicates “initial request”, then when the AMF forwards the 5GSM message to the selected SMF, the AMF should also indicate if the UE is registered for disaster roaming service. This indication may be a new indication that is sent using any message that is used on the protocol between the AMF and the SMF. The indication may be part of a new field or IE, or may be part of an existing field or IE.

In a second embodiment, the UE informs the SMF about a UE registered for disaster roaming service. Here, the UE should provide an indication regarding whether or not it is registered for disaster roaming service. This indication may be part of an existing IE or field, or may be introduced as a new IE or field. This indication may be sent by the UE in any 5GSM message that is sent to an SMF after the UE determines that it is registered for disaster roaming (e.g. based on the UE indicating that is it registering for disaster roaming during the registration procedure and/or based on an indication that the UE receives e.g. in the 5GS registration result), where the indication informs the UE that it is registered for disaster roaming service.

As such, if the UE determines that it is registered for disaster roaming, then when the UE sends a 5GSM NAS message to the SMF, e.g. the PDU Session Establishment Request message, then the UE should indicate whether it is registered for disaster roaming service, where this indication should be provided in the 5GSM NAS message using any existing field/IE or a new field/IE. If the UE is indeed registered for disaster roaming, then the UE should indicate so in the 5GSM message e.g. in the PDU Session Establishment Request message.

The following describes the SMF behaviour after receiving an indication that a UE is registered for disaster roaming service. It should be noted that the indication that is received by the SMF may be from the AMF or the UE (according to the first or second embodiment above), or both, as described earlier or by using any other method. The following is also applicable even if other methods (different from those described above) are used at the SMF to determine that a UE is registered for disaster roaming service. The important point is that the SMF is aware, by whatever means, that the UE is registered for disaster roaming.

When an SMF determines that a UE is registered for disaster roaming service, the SMF should send a response 5GSM message (e.g. PDU Session Establishment Accept message) without including any information or IE that is related to S1 mode or that is related to the potential transfer of the PDU session from N1 mode to S1 mode. One example of such IEs that should not be included by the SMF in the 5GSM NAS message is the Mapped EPS bearer contexts IE.

Alternatively, the SMF may verify if the UE is registered for disaster roaming. If the SMF determines that the UE is not registered for disaster roaming, then the SMF provides the UE with the mapped EPS bearer contexts (e.g. the SMF provides/includes the Mapped EPS bearer context IE when the other necessary conditions are met) in the 5GSM NAS message. Otherwise, if the SMF determines that the UE is registered for disaster roaming service, then the SMF does not provide the Mapped EPS bearer contexts IE to the UE. As such, embodiments of the disclosure require that the SMF determination to provide this IE to the UE should now take into account the UE's registration type i.e. whether or not the UE is registered for disaster service, as described above, in order to provide (or not provide) certain IEs e.g. the Mapped EPS bearer contexts IE.

For example, the new SMF behaviour may be described as follows.

If interworking with EPS is supported for the PDU session and/or the UE is not registered for disaster roaming, the SMF shall set in the PDU SESSION ESTABLISHMENT ACCEPT message:
a) the Mapped EPS bearer contexts IE to the EPS bearer contexts mapped from one or more QoS flows of the PDU session; and
b) the EPS bearer identity parameter in the Authorized QoS flow descriptions IE to the EPS bearer identity corresponding to the QoS flow, for each QoS flow which can be transferred to EPS.

Note that the steps set out herein are not limited to the Mapped EPS bearer contexts IE only. They can equally apply to the Authorized QoS flow descriptions IE and/or any other field/parameter that is related to EPS, or that is related to interworking with EPS, where the field/parameter may be provided to the UE in any IE e.g. the Mapped EPS bearer contexts IE or the Authorized QoS flow descriptions IE. As such, all the detail herein applies to any parameter/field that is normally used/sent due to interworking regardless of the IE in which the field/parameter is sent, or regardless of the 5GSM in which the parameter/field is sent (to the UE).

The following procedure may use the EPS bearer identity in the solution description. However, this should be considered to be an example and not a limitation. As such the procedure would also apply in a similar manner for any field/parameter or IE that is related to interworking with EPS in terms of at least session management aspects e.g. for potential transfer of PDU sessions.

As such, the SMF should only send an EPS bearer identity in the Authorized QoS flow descriptions IE if the SMF determines that a UE is not registered for disaster roaming. Otherwise, if the SMF determines that a UE is not registered for disaster roaming, then the SMF can provide the EPS bearer identity to the UE in the Authorized QoS flow descriptions IE.

Note that all the details provided above for mapped EPS bearer context (or Mapped EPS bearer contexts IE) apply in the same manner for the EPS bearer identity and/or the Authorized QoS flow descriptions IE.

As such, the SMF behaviour is modified in order to determine whether at least one parameter/field/IE should be provided to the UE in a 5GSM message, where this determination requires verifying if a UE is registered for disaster roaming or not, and where the field/parameter/IE is related to interworking of a PDU session between N1 mode and S1 mode (e.g. the Authorized QoS flow descriptions IE or Mapped EPS bearer contexts IE, etc). The SMF does not provide the field/parameter/IE if the UE is registered for disaster roaming. On the other hand, if the SMF determines that a UE is not registered for disaster roaming, then the SMF can provide EPS related parameters/fields/IEs.

Note that the details set out above, for both embodiments, may be applied for the case when the PDU session is not a PDU session for emergency services. Otherwise, if the PDU session is for emergency services, then the network considers the session to be transferable to EPS and may provide the relevant EPS QoS parameters.

Further embodiments of the disclosure relate to techniques to correct QoS errors when registered for disaster roaming.

As mentioned earlier, the UE may receive QoS parameters that are related to a potential transfer of the PDU session although this should not happen. These parameters may be sent by the SMF unknowingly (i.e. without knowing that the UE is registered for disaster roaming service) or erroneously (which can currently happen as is the case with numerous other erroneous scenarios).

When the UE that is registered for disaster roaming service receives a 5GSM NAS message, e.g. a PDU Session Establishment Accept message, or a PDU Session Modification Command message, hereafter referred to a 5GSM NAS message or NAS 5GSM message, then the UE must verify for certain cases (or errors or conditions) based on which the UE may take certain actions to correct any potential QoS errors.

Note that the steps outlined herein may use specific IEs as examples, but this should not be considered to be a limitation. Instead, these should be considered merely as examples of IEs which may be used. The skilled person will appreciate that others may be used, as is set out elsewhere herein. As such, any parameter/field/IE that is related to EPS or that is related to 5GSP EPS or interworking of PDU session or interworking with EPS in general would be suitable for use with embodiments of the present disclosure.

The UE should verify if the NAS 5GSM message contains a Mapped EPS bearer contexts IE. To do this, the UE may verify if one or more specific parameters are included in the IE (e.g. Mapped (extended) EPS QoS parameters or Traffic flow template, etc). If the Mapped EPS bearer contexts IE is included, or any specific parameter(s) within this IE, then the UE may take the following actions in any order and/or combination:
If the UE is registered for disaster roaming service, the UE may consider that the PDU session is not transferable to EPS (S1 mode). As such, if the UE uses or performs in inter-system change to S1 mode for any reason, then the UE may locally release this PDU session/PDN connection i.e. the UE should not transfer this PDU session to S1 mode (unless it is a PDU session for emergency services). If the PDU session in question is a PDU session that is (used) for emergency services, then the steps above should not apply and the UE should instead consider the session to be transferable to EPS (S1 mode). In this case i.e. when the PDU session is for emergency services, the UE does not apply the behaviour described next. Optionally, if the PDU session in question is for an emergency PDU session (and optionally the UE had indicated that it supported S1 mode), then the UE does not consider the availability of EPS QoS parameters as an error and would not behave as described below. On the other hand, if the PDU session is not for emergency services, then the UE behaves as described below i.e. the UE can locally delete any related EPS QoS parameters.
If the UE is registered for disaster roaming service (or if the UE is registered on a PLMN, optionally a forbidden PLMN, which was selected for disaster roaming service), the UE may locally delete the Mapped EPS bearer contexts IE or any (one or more) specific parameter in the IE. The UE may consider this an error or may not consider this an error. For example, the UE may delete any corresponding mapped EPS bearer context(s) for which the IE was received and the UE may do so locally. This behaviour (i.e. to locally delete the Mapped EPS bearer contexts IE or its contents) may be applied/performed if the PDU session is not for emergency services. Therefore, if the PDU session is indeed for emergency services, then the UE does not consider this to be an error and need not delete any corresponding mapped EPS bearer context(s) (for which a related IE was received). As such, the PDU session for emergency services is considered transferable by the UE.
If the UE is registered for disaster roaming service (or if the UE is registered on a PLMN, optionally a forbidden PLMN, which was selected for disaster roaming service), the UE may initiate the PDU session modification procedure, i.e. send the PDU Session Modification Request message, to delete the mapped EPS bearer contexts. The UE may include in the NAS 5GSM message a new 5GSM cause value or may include an existing 5GSM cause value e.g. #85“Invalid mapped EPS bearer identity”. This behaviour (i.e. to perform a PDU session modification as described above) may be applied/performed if the PDU session is not for emergency services. Therefore, if the PDU session is indeed for emergency services, then the UE does not consider this to be an error and need not perform the PDU session modification procedure to delete mapped EPS bearer context(s) (for which a related IE was received). As such, the PDU session for emergency services is considered transferable by the UE.
Alternatively, the UE may initiate the PDU session release procedure, i.e. send a PDU Session Release Request message. The UE may include in the NAS 5GSM message a new 5GSM cause value or may include an existing 5GSM cause value e.g. #85 “Invalid mapped EPS bearer identity”. This behaviour (i.e. to initiate the release of the PDU session as described above) may be applied/performed if the PDU session is not for emergency services. Therefore, if the PDU session is indeed for emergency services, then the UE does not consider this to be an error and need not perform the PDU session release procedure to release the session. As such, the PDU session for emergency services is considered transferable by the UE and should not be released.
The reception of the Mapped EPS bearer contexts IE may be considered as an error if the UE is registered for disaster roaming service. Alternatively, the UE may locally delete the mapped EPS bearer context(s) and not consider the event as an error. This behaviour to locally delete the mapped EPS bearer context(s) may be applied/performed only for a PDU session that is not for emergency services. Therefore, if the PDU session is not for emergency services, then the Mapped EPS bearer contexts IE may be deleted when the UE is registered for disaster roaming service. Otherwise, for a UE which is registered for disaster roaming service, if the PDU session in question is an emergency PDU session (or is used for emergency service), then the availability of a Mapped EPS bearer contexts IE should not be considered to be an error and need not be deleted locally or explicitly using signalling.

The steps above apply in the same manner if the UE receives the Authorized QoS flow descriptions IE with an EPS bearer identity which is received as a parameter of the authorized QoS flow descriptions:
If the UE is registered for disaster roaming service (or if the UE is registered on a PLMN, optionally a forbidden PLMN, which was selected for disaster roaming service), the UE may consider that the PDU session is not transferable to EPS (S1 mode) if the session is not a PDU session for emergency services. As such, if the UE uses or performs in inter-system change to S1 mode for any reason, then the UE may locally release this PDU session/PDN connection i.e. the UE should not transfer this PDU session to S1 mode (unless it is a PDU session for emergency services). If the PDU session in question is a PDU session that is (used) for emergency services, then the proposal above should not apply and the UE should instead consider the session to be transferable to EPS (S1 mode)
If the UE is registered for disaster roaming service (or if the UE is registered on a PLMN, optionally a forbidden PLMN, which was selected for disaster roaming service), the UE may locally delete the EPS bearer identity that was received in the IE optionally if the PDU session is not a PDU session for emergency services. The UE may consider this an error or may not consider this an error. E.g. the UE may delete any corresponding received EPS bearer identity that may have been received in the IE, and the UE may do so locally. E.g. the UE may/should/shall locally remove the EPS bearer identity (EBI) from the parameters list field of such one or more authorized QoS flow descriptions if an EBI is received in the IE and optionally the UE is registered for disaster roaming service, and optionally when the PDU session is not a PDU session for emergency services
If the UE is registered for disaster roaming service (or if the UE is registered on a PLMN, optionally a forbidden PLMN, which was selected for disaster roaming service), the UE may initiate the PDU session modification procedure, i.e. send the PDU Session Modification Request message, to delete QoS flow description for which an EPS bearer identity was also received. The UE may include in the NAS 5GSM message a new 5GSM cause value or may include an existing 5GSM cause value e.g. #85 “Invalid mapped EPS bearer identity”. This behaviour (i.e. to perform a PDU session modification as described above) may be applied/performed if the PDU session is not for emergency services. Therefore, if the PDU session is indeed for emergency services, then the UE does not consider this to be an error and need not perform the PDU session modification procedure to delete QoS flow description for which an EPS bearer identity was also received. As such, the PDU session for emergency services is considered transferable by the UE.
Alternatively, the UE may initiate the PDU session release procedure, i.e. send a PDU Session Release Request message. The UE may include in the NAS 5GSM message a new 5GSM cause value or may include an existing 5GSM cause value e.g. #85 “Invalid mapped EPS bearer identity”. This behaviour (i.e. to initiate the release of the PDU session as described above) may be applied/performed if the PDU session is not for emergency services. Therefore, if the PDU session is indeed for emergency services, then the UE does not consider this to be an error and need not perform the PDU session release procedure to release the session. As such, the PDU session for emergency services is considered transferable by the UE and should not be released.
The reception of an EPS bearer identity may be considered as an error if the UE is registered for disaster roaming service. Alternatively, the UE may locally delete the EBI and not consider the event as an error. This behaviour to locally delete the EPS bearer identity may be applied/performed only for a PDU session that is not for emergency services. Therefore, if the PDU session is not for emergency services, then the EPS bearer identity may be deleted locally when the UE is registered for disaster roaming service. Otherwise, for a UE which is registered for disaster roaming service, if the PDU session in question is an emergency PDU session (or is used for emergency service), then the availability of an EPS bearer identity should not be considered to be an error and need not be deleted locally or explicitly using signalling.

Note that the methods and steps above may apply or be applied in any order and in any combination.

In general, for a UE which is registered for disaster roaming service (or if the UE is registered on a PLMN, optionally a forbidden PLMN, which was selected for disaster roaming service), and for any PDU session that the UE has, if the PDU session is not for emergency services, then the UE may locally delete any related EPS QoS parameter that was received from the network and as such the UE considers the PDU session to not be transferable to EPS. On the other hand, if the PDU session is for emergency services, then the UE may not/need not/should not delete any related EPS QoS parameter that was received from the network and as such the UE considers the PDU session to be transferable to EPS. It should be noted that an EPS QoS parameter may be any of the previously listed parameters and/or contents of the listed IE that are used for carrying EPS QoS contexts/parameters.

In a still further embodiment, there is provided a solution to handle a PDU session that already had mapped EPS bearer context before disaster roaming.

Here, the UE may have been registered on a PLMN with which at least one PDU session was established such that the PDU session is transferable to EPS. For example, the UE may have determined (prior to registering for disaster roaming) that at least one PDU session can be transferred to EPS (S1 mode) and for which the PDU session contains/includes mapped EPS bearer context (in any form or based on any parameter as described above). The UE may later perform disaster roaming (i.e. the UE later registers for disaster roaming) such that a PDU session that is subject to be transferred to S1 mode is already available or was already established by the UE. When the UE registers for disaster roaming and the UE already has a PDU session for which the UE has determined that the session can be transferred to EPS (e.g. based on any criterion or e.g. based on the presence of mapped EPS bearer context of any form as have been described before, e.g. an associated EBI or an associated mapped EPS bearer context), then the UE may take any of the following actions in any order and/or combination:
If the UE is registered for disaster roaming service, the UE may consider that the PDU session is not transferable to EPS (S1 mode) optionally if the PDU session is not for emergency services. As such, if the UE uses or performs in inter-system change to S1 mode for any reason, then the UE may locally release this PDU session/PDN connection i.e. the UE should not transfer this PDU session to S1 mode (unless it is a PDU session for emergency services). If the PDU session in question is a PDU session that is (used) for emergency services, then the steps above should not apply and the UE should instead consider the session to be transferable to EPS (S1 mode)
The UE may maintain/keep any mapped EPS bearer context that was already present although the UE may consider the session to be non-transferable to EPS. As such, if the UE goes to another PLMN in which the UE no longer registers for disaster roaming, then the UE may consider the session to be transferable to EPS
If the UE is registered for disaster roaming service and optionally if the PDU session is not for emergency services, the UE may locally delete any mapped EPS bearer contexts that are already available in the UE or any related EPS bearer context parameter e.g. EBI, where any such parameter may be associated with a QoS flow description(s) or a mapped EPS bearer context, or both. E.g. the UE may locally delete any corresponding mapped EPS bearer context(s) or EBI.
If the UE is registered for disaster roaming service and optionally if the PDU session is not for emergency services, the UE may initiate the PDU session modification procedure, i.e. send the PDU Session Modification Request message, to delete any existing mapped EPS bearer contexts (or other parameters that are related to interworking). The UE may include in the NAS 5GSM message a new 5GSM cause value or may include an existing 5GSM cause value e.g. #85 “Invalid mapped EPS bearer identity”.
Alternatively, if the PDU session is not for emergency services the UE may initiate the PDU session release procedure, i.e. send a PDU Session Release Request message. The UE may include in the NAS 5GSM message a new 5GSM cause value or may include an existing 5GSM cause value e.g. #85 “Invalid mapped EPS bearer identity”
The existence/presence of a mapped EPS bearer context and/or an EBI (corresponding to a QoS flow) may be considered as an error if the UE is registered for disaster roaming service and optionally if the PDU session is not for emergency services. Alternatively, the UE may locally delete the mapped EPS bearer context(s) and/or EBI and not consider the event as an error optionally if the PDU session is not for emergency services
Alternatively, the UE may consider any previous PDU sessions that were known to be transferrable to EPS (S1 mode) to be transferable and may hence be transferred if needed, where this should optionally only be applied to a PDU session for emergency services. However, any new PDU sessions that are established while registered for disaster roaming may be considered to be not transferable and as such any previous technique above may be used for such PDU sessions e.g. the UE performs a PDU session modification procedure to delete any EPS related parameter when any is received and the UE is registered for disaster roaming.

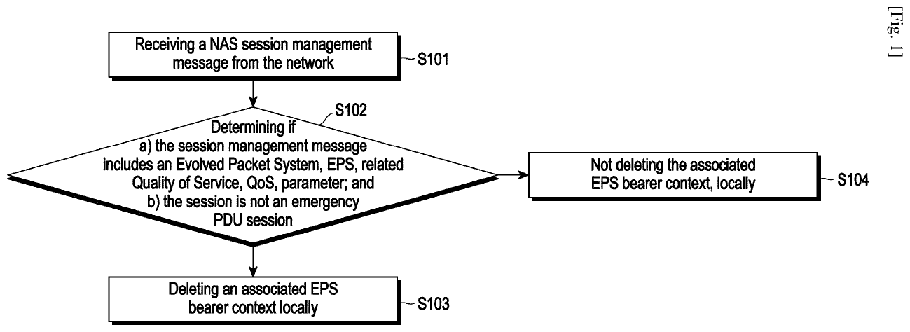

FIG. 1 shows a flowchart illustrating a method according to an embodiment of the present disclosure. At step S101, a UE, connected to a network for disaster roaming, receives a Non Access Stratum, NAS, session management message from the network. At S102, a determination is made if a) the session management message includes an Evolved Packet System, EPS, related Quality of Service, QoS, parameter; and b) the session is not an emergency PDU session. If both are true, then at S103, the UE deletes an associated EPS bearer context, locally. If one or both of a) and b) are not true than the UE maintains or does not delete the associated EPS bearer context, locally.

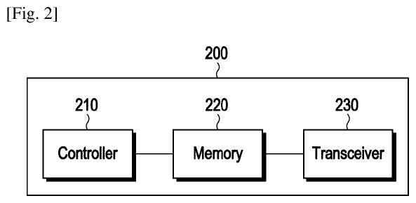

FIG. 2 shows a block diagram of a device according to an embodiment of the present disclosure. The device (200) may be the UE, or a device implementing a network entity described herein.

The device (200) may comprise a controller (110), a transceiver (230) and a memory (220).

The controller (210) may be implemented as at least one processor. The controller (210) may be coupled to other components (for example, the transceiver (230) and the memory (220)) of the device (200). The controller (210) may operated to perform operations of the device (200) described herein. The controller (210) may cause the device (200) to perform operations described herein.

The transceiver (230) may be configured as communication circuitry. The device (200) may communicate with other entity through the transceiver (230). The transceiver may support various radio access technologies including, but not limited to, CDMA, LTE, LTE-A, Bluetooth, OFDM, or NFC.

The memory (220) may store temporary data or non-temporary data for operations of the device (200) or the controller (210). The memory may store instructions. When the instructions are executed by the controller (210), the instruction may cause the controller (210) or the device (200) to perform operations described herein.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. A method for managing protocol data unit (PDU) session establishment, by a user equipment (UE) connected to a network for disaster roaming, the method comprising:
receiving a non-access stratum (NAS) session management message from the network;
determining whether the NAS session management message includes an evolved packet system (EPS) related quality of service (QoS) parameter, and—whether a session related to the NAS session management message is an emergency PDU session; and
deleting an associated EPS bearer context, based on determining that the NAS session management message includes the EPS related QoS parameter, and that the session is not the emergency PDU session.

2. The method of claim 1, wherein the NAS session management message is one of a PDU session establishment accept message and a PDU session modification command message.

3. The method of claim 1, wherein the QoS parameter includes at least one of an EPS bearer identifier (ID) or mapped EPS bearer context.

4. The method of claim 1, further comprising maintaining the associated EPS bearer context based on determining that the NAS session management message does not include the EPS related QoS parameter, or that the session is the emergency PDU session.

5. A user equipment, UE, connected to a network for disaster roaming, the UE comprising:
a transceiver; and
a controller coupled to the transceiver, wherein the controller is configured to:
receive a non-access stratum (NAS) session management message from the network,
determine whether the NAS session management message includes an evolved packet system (EPS) related quality of service (QoS) parameter, and whether a session related to the NAS session management message is an emergency protocol data unit (PDU) session, and
delete an associated EPS bearer context based on determining that the NAS session management message includes the EPS related QoS parameter, and that the session is not the emergency PDU session.

6. The UE of claim 5, wherein the NAS session management message is one of a PDU session establishment accept message and a PDU session modification command message.

7. The UE of claim 5, wherein the QoS parameter includes at least one of an EPS bearer identifier (ID) or mapped EPS bearer context.

8. The UE of claim 5, wherein the controller is further configured to maintain the associated EPS bearer context based on determining that the NAS session management message does not include the BPS related QoS parameter, or that the session is the emergency PDU session.

9. A non-transitory computer readable storage medium storing instructions which, when executed by a controller of a user equipment (UE) connected to a connected to a network for disaster roaming, cause the UE to perform operations comprising:
receiving a non-access stratum (NAS) session management message from the network;
determining whether the NAS session management message includes an evolved packet system (EPS) related quality of service (QoS) parameter, and whether a session related to the NAS session management message is an emergency protocol data unit (PDU) session; and
deleting an associated EPS bearer context based on determining that the NAS session management message includes the EPS related QoS parameter, and that the session is not the emergency PDU session.

10. The non-transitory computer readable storage medium of claim 9, wherein the NAS session management message is one of a PDU session establishment accept message and a PDU session modification command message.

11. The non-transitory computer readable storage medium of claim 9, wherein the QoS parameter includes at least one of an EPS bearer identifier (ID) or mapped EPS bearer context.

12. The non-transitory computer readable storage medium of claim 9, wherein the operations further comprises maintaining the associated EPS bearer context based on determining that the NAS session management message does not include the EPS related QoS parameter, or that the session is the emergency PDU session.
